(19) United States
(12) Patent Application Publication
(10) Pub. No.: US 2006/0252640 A1
(43) Pub. Date: Nov. 9, 2006

(54) Metal or metal oxide porous material prepared by use of dextran or related soluble carbohydrate polymer

(76) Inventors: Dominic Walsh, Bath (GB); Laura Arcelli, Perugia (IT); Stephen Mann, Bristol (GB); Toshiyuki Ikoma, Ibaraki (JP); Junzo Tanaka, Ibaraki (JP)

Correspondence Address: WENDEROTH, LIND & PONACK, L.L.P., 2033 K STREET N. W., SUITE 800, WASHINGTON, DC, 20006-1021, US

(21) Appl. No.: 10/539,348

(22) PCT Filed: Dec. 17, 2002
(86) PCT No.: PCT/JP02/13183

§ 371 Date: May 2, 2006

(51) Int. Cl. B01J 23/50

(52) U.S. Cl. 502/347; 423/632; 423/593.1; 423/592.1

(57) ABSTRACT

The present invention provides a new metal or metal oxide porous material and a preparation method thereof, and more particularly concerns a new sponge-shaped noble metal, especially a silver porous material that is useful as a catalyst for an organic synthetic reaction such as an epoxidation reaction and partial oxidation reaction, and a functional material for electronic devices, heat dissipation and bacterial filtration and a preparation method thereof, as well as such a new silver catalyst.

### TECHNICAL FIELD

The invention of the present application relates to a metal or metal oxide porous material and a preparation method thereof, and more particularly concerns a new sponge-shaped silver porous material that is useful as a catalyst for an organic synthetic reaction such as an epoxidation reaction and a partial oxidation reaction, and a functional material for electronic devices, heat dissipation and bacterial filtration and a preparation method thereof, as well as such a new silver catalyst.

### BACKGROUND ART

Conventionally, silver is used as a catalyst for an epoxidation reaction, for example for ethane and pentane and for a partial oxidation reaction of methanol to formaldehyde.

A material made of sponge-shaped metal silver has been known as one type of such silver material. Conventionally, sponge-shaped metal silver has been prepared by the following method:

British Patent 1,074,017 discloses a porous oxidation catalyst provided by a method comprising of applying a metal compound to a temporary insoluble support, which can be destroyed by combustion under in the presence of oxygen. British Patent 1,074,018 discloses a porous metal body for a suitable oxidation catalyst provided by a method using a heat-resistant material being substantially unchanged by the. thermal decomposition.

U.S. Pat. No. 4,007,135 discloses an oxidation catalyst using a porous heat resisting support. The porous material, such as alumina and pumice is dipped in a solution of silver compound, and then baked.

However, in the case of sponge-shaped silver prepared by this conventional method, the following limitations and problems have been raised in its structural characteristics:

Because the conventional method disclosed in British Patent 1,074,017 needs a temporary support destroyed by combustion under a condition of oxygen presence, and the conventional methods disclosed in British Patent 1,074,018 and U.S. Pat. No. 4,007,135 use heat resistant material, residual materials are not completely decomposed and thus decrease the catalyst activity.

Also conventional unsupported silver catalysts have a surface area in the region of 0.2 m²/g, the silver sponge material prepared by the method here described is of the order of 1 m²/g and is thus similar to conventional supported catalysts without the requirement of a support material.

Therefore, in order to solve the above-mentioned conventional problems, the objectives of the invention of this application is to provide a new silver porous material which is easily selected and controlled in its structure and shape, and easily prepared and formed by heating in air, which can easily have additional metals or metal oxide particles incorporated as promoters and which is also superior in characteristics as a catalyst, etc., a preparation method thereof and a new silver catalyst using such a material.

Additionally, the objectives of the invention of this application is to provide a new porous material relating to the silver porous material which is easily controlled in its structure and shape, and easily prepared and formed by heating in air, which can easily have additional metals or metal oxides particles increasing functional activities, and a preparation method thereof.

### DISCLOSURE OF INVENTION

In order to achieve the above-mentioned objectives, the invention of the present application provides a metal or metal oxide porous material having a rod-shaped crystal. In the second aspect, the present invention provides a sponge material of which rod dimension, pore size and mechanical strength can be selected by heating temperature, in the third aspect, it provides a metal or metal oxide porous material which has communicating pores, and in the fourth aspect, it provides a silver porous material in which a cross-section of the rod-shaped crystal, taken in a direction orthogonal to the length direction, has a maximum external dimension of between 1 μm to 50 μm depending on preparation conditions.

The invention of the present application, according to the inventions above-mentioned, provides a noble metal porous material, particularly, a silver or gold porous material.

The present invention provides a metal or metal oxide porous material, which has surface decorated with particles of metal or metal oxide selected from other kind of metal element or metal oxide.

The present invention provides a preparation method of metal porous material, from use of an aqueous viscous solution of metal salt material and dextran or a related highly water-soluble carbohydrate polysaccharide polymer, which undergoes self-solidification, and is then baked.

The present invention also provides a preparation method of metal oxide porous material, comprising of steps of which an aqueous viscous colloidal solution of metal oxide particles and dextran or a highly water soluble carbohydrate polymer, undergoes self-solidification and is then baked.

Moreover, the invention of the present application provides a preparation method of porous material above-mentioned, wherein a baking process is carried out at a temperature of not less than 500° C. In the another aspect, the present invention provides a preparation method of a silver porous material in which dextran or a highly water soluble carbohydrate polymer in the aqueous viscous solution has a concentration in the range of 10 to 90% by weight and metal salt material or colloidal particles of metal or metal oxide has a concentration in the range of 10 to 90% by weight, and it also provides a preparation method of porous material in which dextran or a highly water soluble carbohydrate polymer in the aqueous viscous solution has a molecular weight in the range of 10,000 to 500,000.

Moreover, the invention of the present application provides a metal or metal oxide catalyst, especially a silver catalyst, which exists as the above-mentioned silver porous material as one kind of effective active component as a primary example. The invention being not limited to the preparation a sponge material composed of silver metal.

### BRIEF DESCRIPTION OF DRAWINGS

FIG. 1 and FIG. 2 SEM are micrographs showing a sponge-shaped silver porous material having communicating pores.

FIG. 3 shows an X-ray diffraction analysis of a sponge-shaped silver porous material obtained by heating at a temperature of 520° C.

FIG. 4 shows a result of thermal gravimetric analysis of a sponge-shaped silver porous material.

FIG. 5 are SEM micrographs of a sponge-shaped silver porous material obtained by baking at (a) 600° C.; (b) 700° C.; (c) 800° C.; (d) 900° C.

FIG. 6 and 7 are SEM micrographs showing a sponge-shaped silver porous material having communicating pores and its surface decorated with particles of copper oxide.

FIG. 8 shows an elemental X-ray analysis of a silver and copper oxide sponge.

FIG. 9 shows an elemental X-ray map showing the surface particles of a silver and copper oxide sponge to be composed of copper (oxide).

FIG. 10(a, b)shows an X-ray diffraction analysis of a silver and copper oxide sponge.

FIG. 11 shows an SEM micrograph of a silver and titania sponge.

FIG. 12 shows an elemental X-ray analysis of a silver titania sponge.

FIG. 13 shows an X-ray diffraction analysis of a silver and titania sponge.

FIGS. 14 and 15 are SEM micrographs of porous gold metal open framework architecture.

FIG. 16 shows an elemental X-ray analysis of a porous gold framework.

FIG. 17 shows an X-ray analysis diffraction analysis of a porous gold framework.

FIG. 18 shows an SEM micrograph of open framework architectures of maghemite iron oxide.

FIG. 19 shows an X-ray diffraction analysis of a maghemite framework.

### BEST MODE FOR CARRYING OUT THE INVENTION

The invention of the present application has the above-mentioned features, and the following description will discuss an embodiment of the present invention.

In particular, the invention of the present application makes it possible to provide a metal or metal oxide porous material, especially silver porous material that is a porous material, and has a rod-shaped crystal.

This porous material, which is made of metal or metal oxide, is provided by the present invention as a sponge-shaped material, and also as a material having communicating pores.

Neither the size of pores of the porous material nor the size of communicating pores is particularly limited. With respect to the maximum external dimension of the cross-section of the rod-shaped crystal that is perpendicular to the length direction, the invention of the present application can provide those having a diameter of approximately 1 μm up to 50 μm, especially 4 μm up to 50 μm depending on preparation conditions. Based upon the maximum external dimension, factors such as the size of pores, the size of communicating pores and the length thereof are determined in accordance with the use and the characteristics of the metal or metal oxide porous material. The sponge material is of sufficient mechanical strength to allow cutting and shaping as required.

The above-mentioned porous material of the invention of the present application is achieved by a preparation method having features as a new process. The present method is characterized in that an aqueous viscous solution of metal salt material, such as silver nitrate (AgNO₃) as a suitable example and dextran or related soluble carbohydrate or polysaccharide solidifies, and then heated and baked. The aqueous viscous solution may be injected into a mold before solidifying. In preferable embodiments, in case of preparation of silver porous material using the silver. nitrate and dextran, the solidifying process occurs at room temperature of 25° C., and the succeeding heating and baking processes are carried out at a temperature of not less than 500° C.

In the heating process at reaching a temperature of approximately 200° C., a reaction represented by the following formulae takes place:
2AgNO₃→2AgNO₂+O₂ [Formula 1]
3AgNO₂→3Ag+2NO+NO₂+O₂ [Formula 2]
C+O₂→CO₂ [Formula 3]
On heating silver nitrate is converted initially to silver nitrite [Formula 1]. Silver nitrite is then reduced to silver [Formula 2]. In this case, dextran is changed into carbon dioxide through burning in the oxygen released from the decomposition of the silver nitrate [Formula 3].

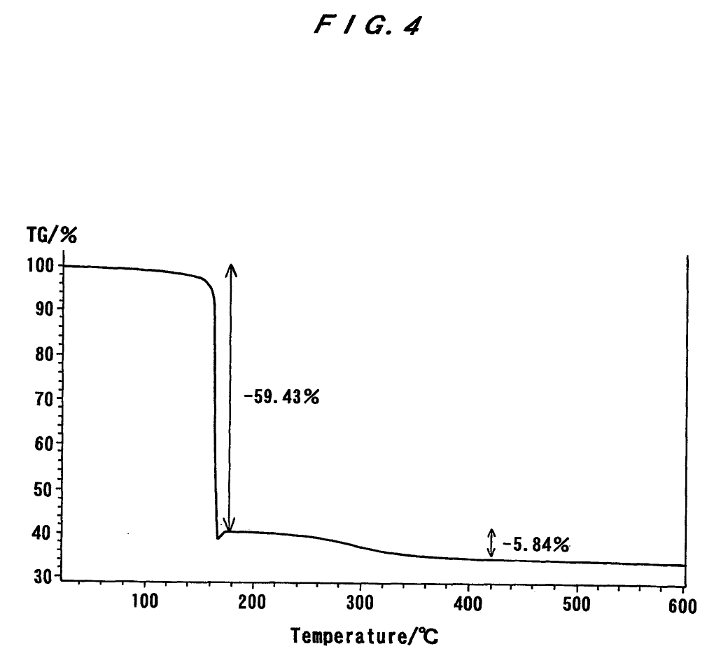

Thermo gravimetric analysis data (FIG. 4) shows that the sequence of reactions of Formula 1 through 3 occurs rapidly in succession or simultaneously. Traces of contaminants are subsequently removed by further heating to temperatures over 500° C.

In the above-mentioned reactions preparing a silver porous material, the aqueous viscous solution is preferably formed so that the concentration of dextran is set in-the range of 10 to 80% by weight, more preferably, 20 to 60% by weight while the concentration of silver nitrate is set in the range of 15 to 50% by weight, more preferably, 35 to 45% by weight. Moreover, at this time, the molecular weight of dextran is preferably set in the range of approximately 20,000 to 120,000, more preferably, in the range of 60,000 to 80,000.

In both of the cases, the invention of the present application makes it possible to prepare a silver porous material very easily by using silver nitrate and dextran.

Then, the silver porous material, provided by the invention of the present application, can be used as an effective active component to be contained in a silver catalyst. This catalyst is effectively used for example in an epoxidation reaction, and also used as a partially oxidizing reaction catalyst in an oxidation reaction of methanol and formaldehyde.

Further to this described method for the preparation of a pure silver sponge material, addition of metal salts or other particles to the described silver nitrate/dextran reaction mixture results in the formation of silver composite materials of similar sponge morphology containing the additive as metal oxide or metal particles.

Further, other soluble metal salts, for example copper nitrate, nickel nitrate etc, may be used in place of silver nitrate to form a viscous solution with dextran and subjected to heating and baking to form open framework architectures of metal oxide or metal.

Further, preformed nanoparticles or micro particles, for example gold, titania or magnetite colloids, may be added to a viscous dextran solution, the solution air dried and subjected to heating and baking to remove dextran and form open framework architectures of the fused particles.

The following description will further discuss the present invention by means of examples.

The present invention, of course, is not limited by the following examples.

### EXAMPLE

### Example 1

To distilled water of 20% by weight were mixed dextran (average molecular weight: 70,000) of 38% by weight and silver nitrate of 42% by weight to prepare an aqueous viscous solution. This was poured into a mold and solidified at a room temperature of 25° C. within 20 minutes. Next, the resulting solid matter was heated and baked at a temperature of not less than 500° C.

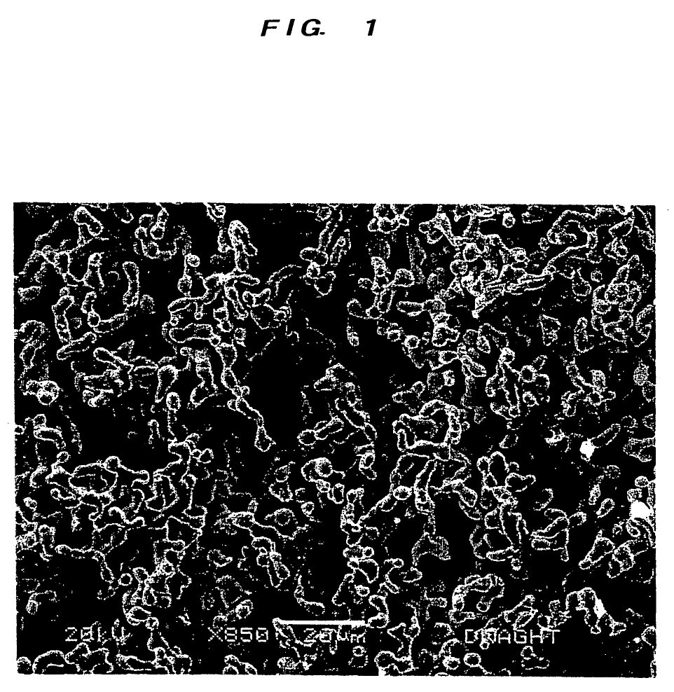

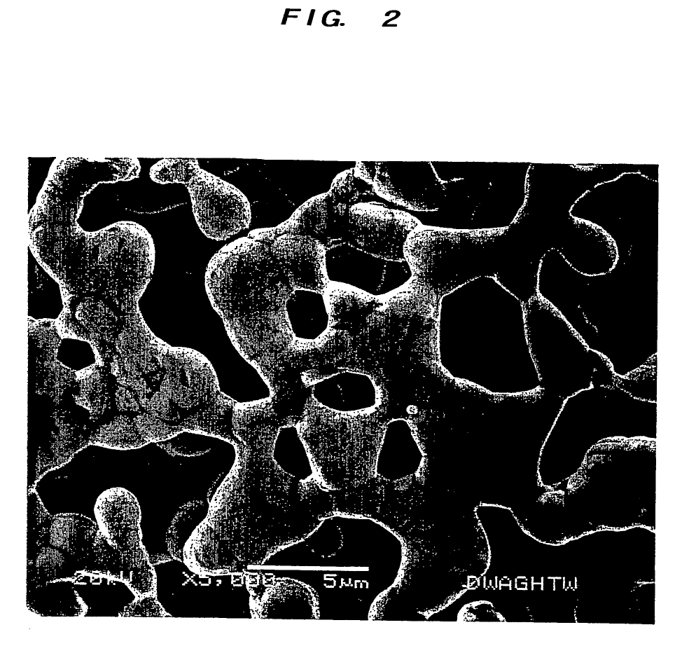

Thus, as shown in SEM micrographs: FIGS. 1 and 2, a sponge-shaped silver porous material having communicating pores was obtained. The material had a rod-shaped crystal, and its maximum external dimension of a cross-section perpendicular to the length direction was 4 μm.

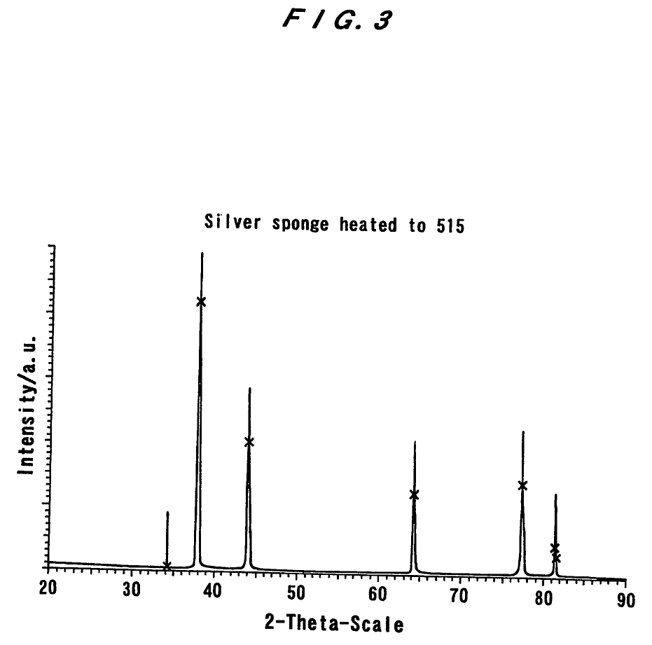

FIG. 3 shows an X-ray diffraction of silver porous material at a temperature o 515° C. FIG. 4 shows the thermo gravimetric analysis data above-mentioned.

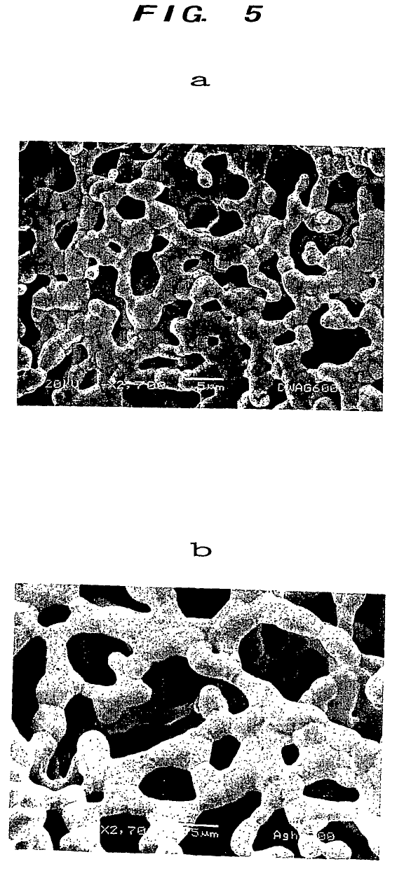

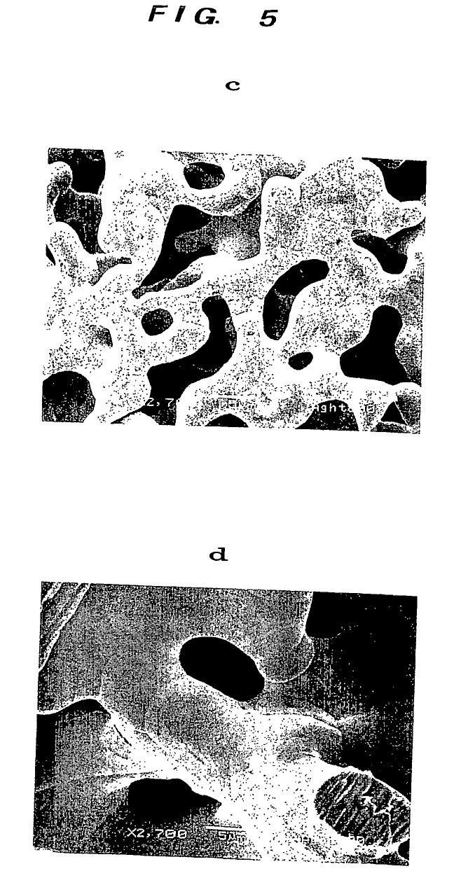

Replication of this procedure using a baking temperature of 600, 700, 800 and 900° C., as shown in FIGS. 5a-5d, produce sponge materials of increased crystal rod diameter and mechanical strength and reduced communicating pore size.

### Example 2

To distilled water of 20% by weight were mixed dextran (average molecular weight: 70,000) of 38% by weight, silver nitrate of 38% by weight and copper nitrate 4% by weight to prepare an aqueous viscous solution. This was poured into a mold and solidified at a room temperature of 25° C. within 1 hour. Next, the resulting solid matter was heated and baked at a temperature of not less than 900° C.

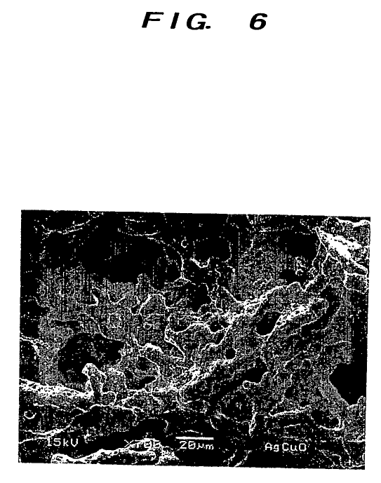

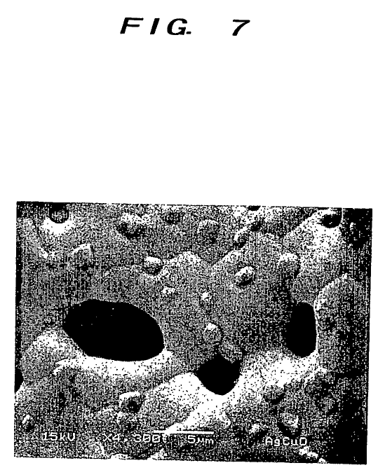

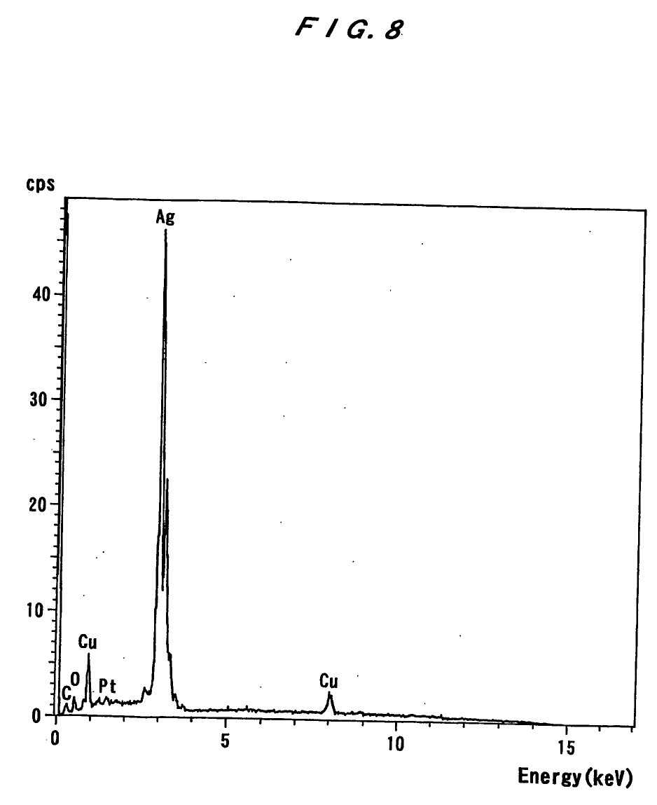

Thus, as shown in SEM micrographs: FIGS. 6 and 7, a sponge-shaped gray/silver porous material having communicating pores was obtained. The material had a rod-shaped crystal, and its maximum external dimension of a cross-section perpendicular to the length direction was 50 μm. In addition, as shown in FIGS. 7-10, roughly spherical particles of copper oxide of diameter not exceeding 4 μm are evenly distributed throughout the material and at its surface. FIG. 8 shows an elemental X-ray analysis of a silver and copper oxide sponge formed by heating at 900° C.

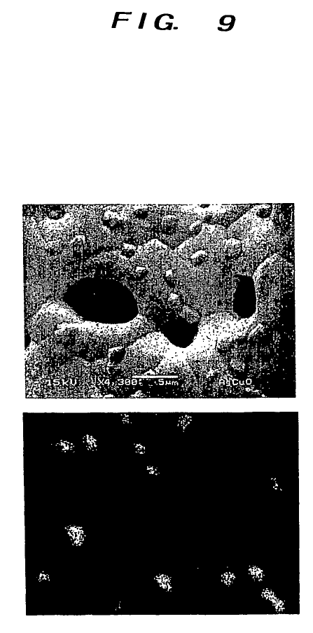

FIG. 9 shows an elemental X-ray map for copper showing the surface particles to be composed of copper.

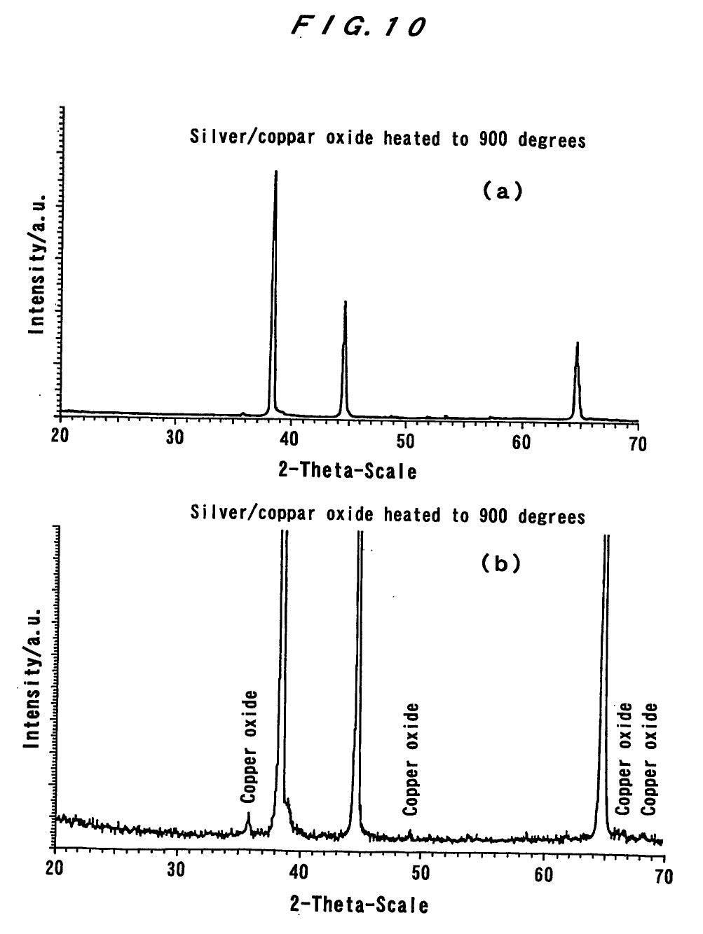

FIG. 10(a) shows an X-ray diffraction of silver and copper oxide sponge material obtained by heating at 900° C. FIG. 10(b) shows an enlargement showing copper oxide peaks.

### Example 3

To distilled water of 20% by weight were mixed dextran (average molecular weight: 70,000) of 40% by weight, silver nitrate of 39.855% by weight and titania particles (colloidal anatase titanium dioxide of average diameter 100 nm) 0.145% by weight to prepare an aqueous viscous solution. This was poured into a mold and solidified at a room temperature of 25° C. within 1 hour. Next, the resulting solid matter was heated and baked at a temperature of not less than 600° C.

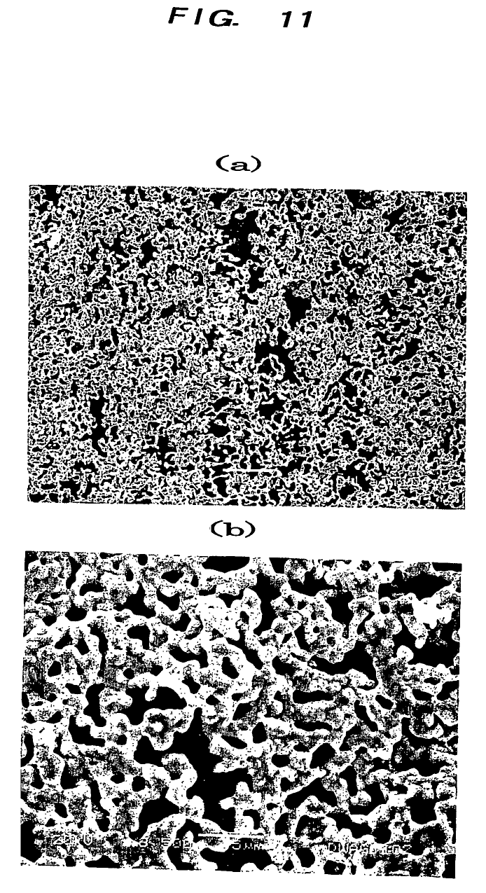

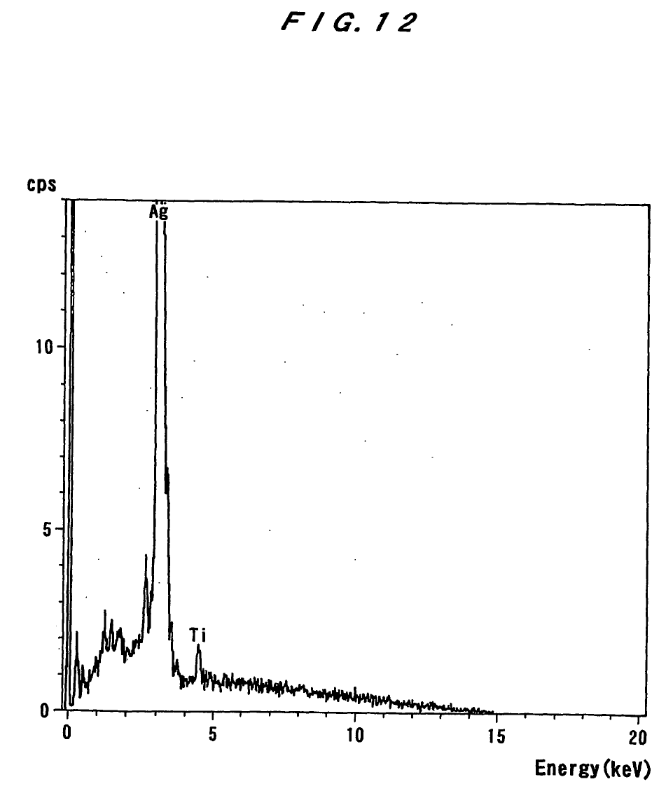

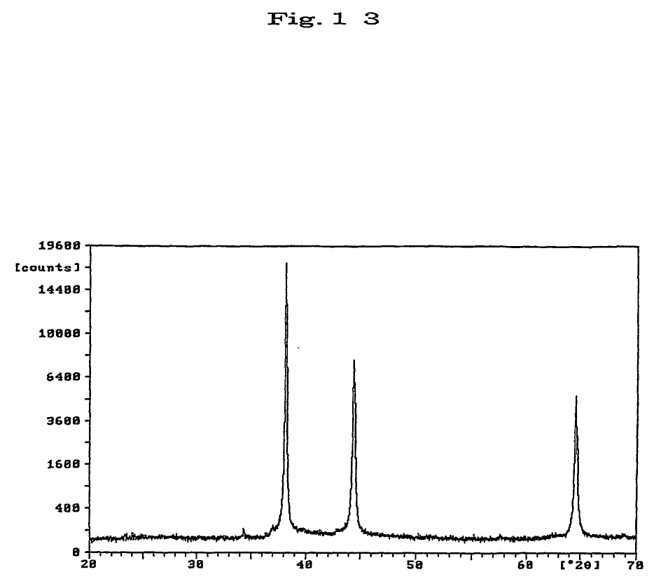

Thus, a sponge-shaped gray/silver porous material having communicating pores was obtained. FIG. 11(a) shows a SEM micrograph of silver and titania sponge material following baking at 600° C. FIG. 11(c) shows the micrograph of at higher magnification. The material had a rod-shaped crystal, and its maximum external dimension of a cross-section perpendicular to the length direction was 4 μm, but more typically 1-2 μm. FIG. 12 shows an elemental X-ray analysis of silver and titania sponge formed y heating at 600° C. FIG. 13 shows an X-ray diffraction analysis of the sponge-shaped silver and titania porous material following heating at 600° C.

### Example 4

To distilled water of 37% by weight were mixed dextran (average molecular weight: 70,000) of 58.5% by weight and gold chloride of 4.5% by weight to prepare an aqueous viscous solution. This was poured into a mold and was air dried at room temperature. Next, the resulting solid matter was heated and baked at a temperature of not less than 800° C.

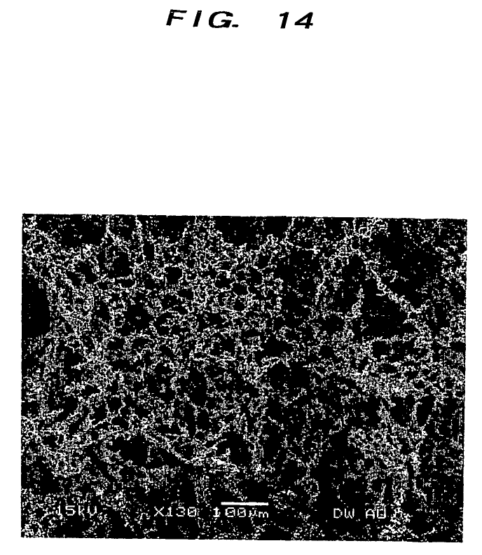

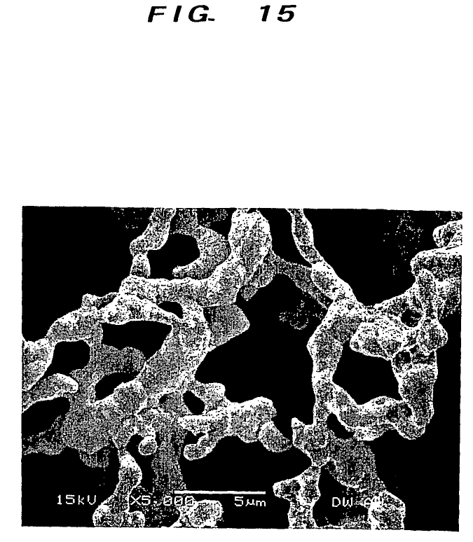

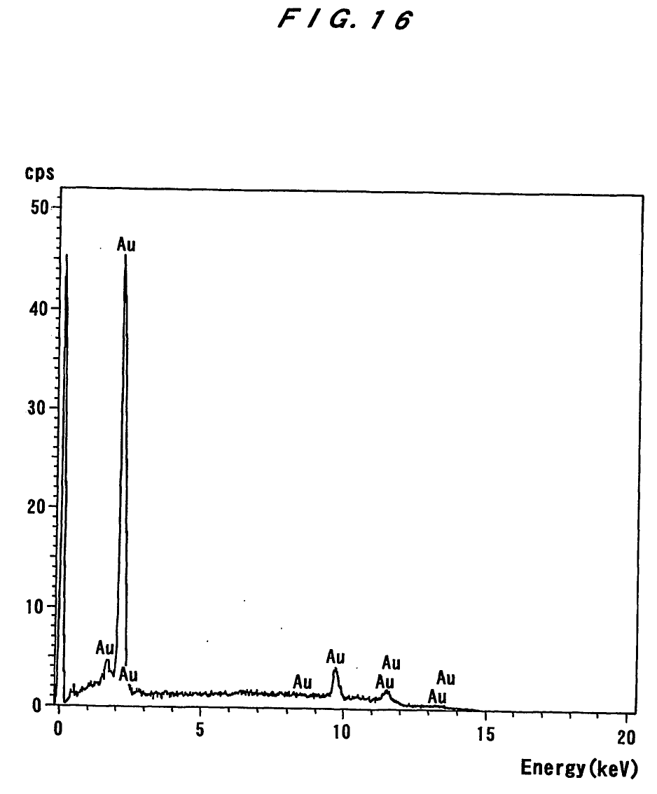

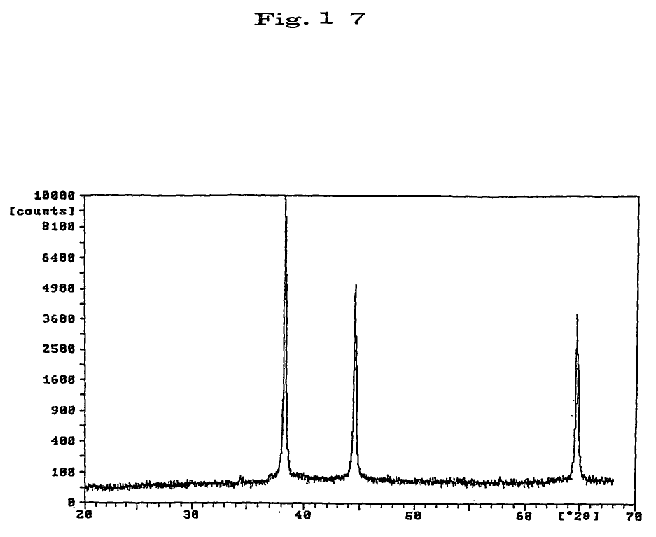

FIGS. 14 and 15 show SEM micrographs of open framework architectures of gold metal. FIG. 16 shows an elemental X-ray analysis data thereof and FIG. 17 shows an X-ray diffraction analysis data thereof.

### Example 5

To distilled water of 36% by weight were mixed dextran (average molecular weight: 70,000) of 56% by weight and magnetite 8 wt % colloid (Fe₃O₄ particles of 2-20 nm in diameter) by weight to prepare an aqueous viscous solution. This was poured into a mold and was air-dried at room temperature.

Next, the resulting solid matter was heated and baked at a temperature of 600° C.

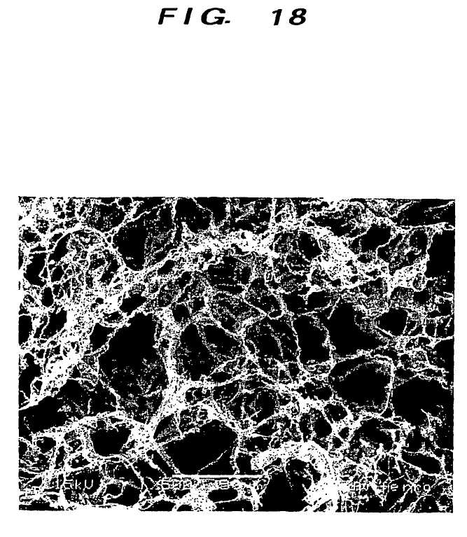

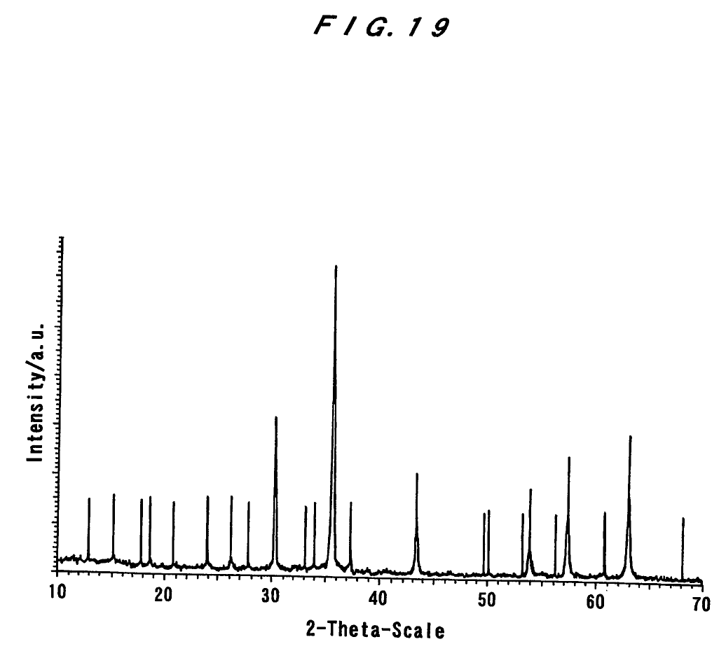

FIG. 18 shows a SEM micrograph of open framework architectures of maghemite iron oxide. FIG. 19 shows an X-ray analysis data thereof.

### INDUSTRIAL APPLICABILITY

As mentioned above, the present invention provides a new metal or metal oxide porous material and a preparation method thereof, and more particularly concerns a new sponge-shaped silver porous material that is useful as a catalyst for an organic synthetic reaction such as an epoxidation reaction and partial oxidation reaction, and a functional material for electronic devices, heat dissipation and bacterial filtration and a preparation method thereof, as well as such a new silver catalyst.

1-23. (canceled)

24. A metal or metal oxide porous material comprising rod-shaped crystals of a metal or metal oxide, which construct an open framework architecture, thereby forming a sponge-like material.

25. The metal or metal oxide porous material of claim 24, which is a soft or hard sponge-like material, depending on its preparation conditions.

26. The metal or metal oxide porous material according to claims 24 or 25, wherein the cross-sectional dimension of the rod-shaped crystal, taken in a direction perpendicular to the length-wise direction, is between 1 μm to 50 μm depending on its preparation conditions.

27. The metal porous material according to claims 24 or 25, wherein the metal is selected from the group consisting of noble metals and transition metals.

28. The metal porous material according to claim 27, wherein the noble metal is silver or gold.

29. The metal porous material according to claims 24 or 25, wherein the metal is composed of more than one type of metal element.

30. The metal oxide porous material according to claims 24 or 25, wherein the metal oxide is selected from transition metal oxides.

31. The metal oxide porous material according to claim 30, wherein the transition metal oxide is iron oxide.

32. The metal oxide porous material according to claims 24 or 25, wherein the metal oxide is composed of more than one type of metal oxide.

33. The metal or metal oxide porous material according to claims 24 or 25, which further comprises particles of a different type of metal element or metal oxide on its surface.

34. A method for preparing the metal or metal oxide porous material of claims 24 or 25, which comprises:
preparing an aqueous viscous solution of metal or metal oxide salt material and dextran or a highly water soluble carbohydrate polymer;
allowing said aqueous viscous solution to self-solidify to form a solid matter; and
baking said solid matter.

35. A method for preparing the metal or metal oxide porous material of claim 33, which comprises:
preparing an aqueous viscous solution of metal or metal oxide salt material, dextran or a highly water soluble carbohydrate polymer, and a different type of metal or metal oxide salt material;
allowing said aqueous viscous solution to self-solidify to form a solid matter; and baking said solid matter.

36. A method for preparing the metal or metal oxide porous material of claims 24 or 25, which comprises:
preparing an aqueous viscous solution of colloidal metal oxide particles and dextran or highly water soluble carbohydrate polymer of glucose;
allowing said aqueous viscous solution to self-solidify to form a solid matter; and
baking said solid matter.

37. The method according to claim 34, wherein the baking process is carried out at a temperature of not less than 500° C.

38. The method according to claim 37, wherein the baking process is carried out at a temperature in a range from not less than 500° C. up to 900° C.

39. The method according to claim 34, wherein the carbohydrate polymer is a polysaccharide.

40. The method according to claim 34, wherein dextran or the carbohydrate polymer in the aqueous viscous solution has a concentration in the range of 10 to 80% by weight and the metal, metal oxide salt material, or colloidal metal oxide has a concentration in the range of 10 to 90% by weight.

41. The method according to claim 40, wherein the metal, metal oxide salt material, or colloidal metal oxide has a concentration in the range of 15 to 60% by weight.

42. The method according to claim 36, wherein dextran or the carbohydrate polymer in the aqueous viscous solution has a molecular weight in the range of 10,000 to 500,000.

43. A metal or metal oxide catalyst which comprises the metal oxide porous material according to claims 24 or 25 as at least one type of effective active component.

44. The metal or metal oxide catalyst according to claim 43, wherein the metal is silver.

45. The method according to claim 34, wherein the metal, metal oxide salt material, or colloidal metal oxide are added to the aqueous viscous solution in the form of nanoparticles or micro particles.

46. The method according to claim 34, wherein the aqueous solution further contains nanoparticles or microparticles of a metal, metal oxide salt material, or colloidal metal oxide.
